(19) United States
(12) Patent Application Publication
(10) Pub. No.: US 2009/0096138 A1
(43) Pub. Date: Apr. 16, 2009

(54) Method for Production of a Honeycomb Seal

(76) Inventor: Reinhold Meier, Dorfen (DE)

Correspondence Address: Davidson, Davidson & Kappel, LLC, 485 7th Avenue, 14th Floor, New York, NY, 10018, US

(21) Appl. No.: 12/225,981

(22) PCT Filed: Mar. 29, 2007
(86) PCT No.: PCT/DE2007/000568

§ 371 Date: Oct. 3, 2008

(30) Foreign Application Priority Data
Apr. 6, 2006 (DE) 10 2006 016 147.5

(51) Int. Cl. B28B 1/24; C04B 33/32; B22F 5/10

(52) U.S. Cl. 264/630; 419/5

(57) ABSTRACT

A method for manufacturing a honeycomb seal by powder-metallurgical injection molding is described wherein, during the powder-metallurgical injection molding; mixing a metal powder and/or a ceramic powder with at least one binding agent to produce a homogeneous mass; subsequently fabricating a molded article for the honeycomb seal having honeycomb-structured cells from the homogeneous mass by injection molding; subsequently performing a debindering process on the molded article; and, subsequently thereto, compacting the molded article via a sintering process to form the honeycomb seal having the desired geometric properties. Prior to the sintering process, partially filling at least some of the cells of the molded article in each case with at least one hollow body, subsequently sintering the molded article together with the hollow bodies that have been introduced into the cells.

The present invention relates to a method for manufacturing a honeycomb seal according to the definition of the species set forth in claim 1.

Present-day gas turbines, in particular aircraft engines, must meet exceedingly stringent requirements in terms of reliability, weight, performance, economy and service life. In recent decades, aircraft engines have been developed, particularly for use in the civil sector, which have fully satisfied the above requirements and have attained a high level of technical perfection. The selection of material, the search for new types of suitable material, as well as the quest for novel manufacturing processes have played a decisive role in aircraft engine development.

The most important materials employed today for aircraft engines or other types of gas turbines are titanium alloys, nickel alloys (also called superalloys) and high-strength steels. The high-strength steels are used for shaft parts, gear parts, for the compressor housing and the turbine housing. Titanium alloys are typical materials used for compressor parts. Nickel alloys are suited for the heat-exposed parts of the aircraft engine. First and foremost, precision casting, as well as forging are known from the related art as methods for manufacturing gas turbine components from titanium alloys, nickel alloys, or other alloys. All high-stress gas turbine components, such as components for a compressor, for example, are forged parts. On the other hand, components for a turbine are typically designed as precision-cast parts.

Powder-metallurgical injection molding is an alternative approach for fabricating or manufacturing complex components. Powder-metallurgical injection molding is related to plastic injection molding, and is also described as metal injection molding (MIM methods). When powder-metallurgical injection molding processes are used, components can be manufactured which attain nearly full density, as well as virtually the static strength of forged parts. By selecting appropriate materials, it is possible to compensate for the dynamic strength, which is typically diminished in comparison to forged parts. Thus, it is already known from the related art, in accordance with German Patent Application DE 102 59 963 A1, to manufacture honeycomb seals by powder-metallurgical injection molding.

Generally, in the powder-metallurgical injection molding of a honeycomb seal, a powder, preferably a metal powder and/or a ceramic powder, is mixed in a first process step with a binding agent and, optionally with a plasticizer, and optionally with other additives to produce a homogeneous mass. From this homogeneous mass, a molded article for the honeycomb seal is fabricated by injection molding. The injection-molded article already has the geometric shape of the honeycomb seal to be manufactured and, thus, honeycomb-structured cells. However, its volume is increased by the volume of the added binding agent and plasticizer. In a debindering process, the binding agent, as well as the plasticizer are removed from the injection-molded article. The molded article is subsequently compacted or shrunk to form a finished honeycomb seal.

Honeycomb seals of this kind, which are manufactured by powder-metallurgical injection molding, are suited, for example, for sealing a radially outside gap between blade tips of rotating rotor blades and a stationary housing. If, besides the sealing function, it is intended that honeycomb seals of this kind also assume a heat-insulating function, then it is already a generally known practice to place a heat-insulating filler into the honeycomb-structured cells of the finish-manufactured honeycomb seal, this heat-insulating filler being permanently bonded to the honeycomb seal by soldering. Substantial outlay for process engineering is entailed in the soldering of heat-insulating fillers to the honeycomb-structured cells of a honeycomb seal.

Against this background, an object of the present invention to devise a novel method for manufacturing a honeycomb seal having a heat-insulating function.

This objective is achieved by a method as set forth in claim 1. In accordance with the present invention, prior to the sintering process, at least some of the cells of the molded article are at least partially filled in each case with at least one hollow body, the molded article being subsequently sintered together with the hollow bodies that have been introduced into the cells.

In accordance with the present invention, prior to the sintering of a molded article of a honeycomb seal to be manufactured by powder-metallurgical injection molding, heat-insulating hollow bodies are placed, i.e., in each case at least one heat-insulating hollow body is placed into at least some of the cells of the molded article.

During the subsequent sintering process, the heat-insulating hollow bodies are permanently bonded to the honeycomb-structured cells of the molded article. Thus, the need for soldering heat-insulating fillers to, the cells of the honeycomb seal, as is standard practice, may be eliminated, thereby achieving an especially efficient method for manufacturing honeycomb seals having a heat-insulating function.

Preferred embodiments of the present invention are derived from the dependent claims and from the following description.

The present invention relates to the manufacturing of a honeycomb seal by powder-metallurgical injection molding. Powder-metallurgical injection molding is also termed metal injection molding (MIM).

In the powder-metallurgical injection molding of a honeycomb seal, a metal powder and/or a ceramic powder are prepared in a first step. In a second step, a binding agent and optionally a plasticizer, as well as optionally other additives are prepared.

The prepared metal powder and/or ceramic powder, as well as the prepared binding agent, and optionally the plasticizer, as well as optionally the other additives are mixed in a third step to form a homogeneous mass. In this context, the volume fraction of the metal powder and/or ceramic powder in the homogeneous mass is preferably between 50% and 70%. The proportion of binding agent and, as the case may be, of plasticizer in the homogeneous mass fluctuates approximately between 30% and 50%.

This homogeneous mass of metal powder and/or ceramic powder, binding agent and, optionally, plasticizer is subsequently further processed by injection molding in a further process step. A molded article of the honeycomb seal to be manufactured is fabricated in the injection molding process. This molded article already has all of the typical features of the honeycomb seal to be manufactured. In particular, the molded article has the geometric shape of the honeycomb seal to be manufactured, thus has honeycomb-structured cells. However, the volume of the molded article is increased by the binding agent content, as well as the plasticizer content. The molded article that has been prepared by injection molding is also referred to as a green compact.

In a subsequent process step, the binding agent and the plasticizer are expelled from the molded article. This step may also be described as a debindering process. The expulsion of binding agents and plasticizers may be accomplished in different ways. Typically, it takes place by fractional thermal decomposition or vaporization. Another option provides for removing the thermally liquefied binding agent and plasticizer by suction through capillary forces, by sublimation or through the use of solvents. Once the debindering process is complete, the molded article is referred to as a brown compact.

Following the debindering process, the molded article is sintered. During the sintering process, the molded article is compacted to form the honeycomb seal having the final geometric properties. Accordingly, during the sintering process, the molded article decreases in size, it being necessary for the dimensions of the molded article to shrink uniformly in all three spatial directions. The linear shrinkage is between 10% and 20%, depending on the binding agent content and the plasticizer content. The sintering may be carried out under various protective gases or under vacuum. Upon completion of the sintering process, the finished honeycomb seal is obtained. If necessary, the honeycomb seal may undergo a finishing procedure following the sintering. However, the finishing procedure is optional. It is likewise possible that a ready-to-install honeycomb seal is obtained immediately following the sintering.

To manufacture a honeycomb seal having a heat-insulating function, in accordance with the present invention, prior to the sintering, at least some of the honeycomb-structured cells of the molded article are at least partially filled in each case with at least one heat-insulating hollow body, the molded article being subsequently sintered together with the hollow bodies that have been introduced into the honeycomb-structured cells. In the process, the heat-insulating hollow bodies enter into a permanent bond with the honeycomb-structured cells of the molded article.

In accordance with the present invention, still preferably before the debindering process, the heat-insulating hollow bodies are preferably introduced into the cells of the still soft molded article, which is in the form of a green compact. Alternatively, however, the hollow bodies may also be introduced into the honeycomb-structured cells of the molded article, which has already partially solidified and is in the form of a brown compact, following the debindering process.

As already mentioned above, the honeycomb-structured cells of the molded article are least partially filled in each case with at least one heat-insulating hollow body. Accordingly, it is possible that just one heat-insulating hollow body is introduced into each honeycomb-structured cell of the molded article. It is likewise possible for a plurality of heat-insulating hollow bodies to be introduced into each honeycomb-structured cell. Filling the honeycomb-structured cells with at least one hollow body connotes that they may be either partially or completely filled with the or with each heat-insulating hollow body.

When a homogeneous mass used for injection molding the molded article of the honeycomb seal to be manufactured is obtained from metal powder, then metallic or metallized hollow bodies are used as heat-insulating hollow bodies. Metallized hollow bodies are those hollow bodies which are metallically coated on the outer surfaces thereof.

When the homogeneous mass used for injection molding the molded article is obtained from a ceramic powder, then ceramic hollow bodies or hollow bodies that have been ceramitized on the outer surfaces thereof are used as hollow bodies. To improve the sinterability of the hollow bodies, they may be optionally provided with a slip coating on the outer surfaces thereof.

The heat-insulating hollow bodies to be introduced into the honeycomb-structured cells of the molded article are preferably adapted in size and shape to the honeycomb-structured cells of the molded article. Especially preferred is the use of hollow bodies in the form of hollow spheres, which are pressed into the honeycomb-structured cells of the molded article. The honeycomb-structured cells of the molded article may have different geometric shapes; thus, they may have round, oval, or also polygonal, in particular, hexagonal contours, for example.

By filling the honeycomb-structured cells of a molded article for a honeycomb seal manufactured by injection molding, prior to the sintering of the same, with hollow bodies, a honeycomb seal having a heat-insulating function may be manufactured in an especially simple manner. Moreover, filling the honeycomb-structured cells with the hollow bodies also enhances the sealing action of the honeycomb seal. In addition, the abrasive wear rate of the blade tips of rotating rotor blades when they rub into the honeycomb seal is reduced, resulting in a longer service life of the same.

Before they are introduced into the honeycomb-structured cells of the molded article, the hollow bodies are preferably cooled to a lower temperature, thus cooled to a temperature that is lower than that of the molded article. Damage to the honeycomb-structured cells upon introduction of the hollow bodies may be thereby avoided.

1-7. (canceled)

8. A method for manufacturing a honeycomb seal by powder-metallurgical injection molding comprising:
mixing a metal powder and/or a ceramic powder with at least one binding agent to produce a homogeneous mass;
fabricating a molded article for the honeycomb seal having honeycomb-structured cells from the homogeneous mass by injection molding;
performing a debindering process on the molded article; and
subsequently compacting the molded article via a sintering process to form the honeycomb seal having the desired geometric properties,
wherein, prior to performing the sintering process, partially filling at least some of the cells of the molded article in each case with at least one hollow body,
and wherein the sintering process includes sintering together the molded article with the hollow bodies that have been introduced into the cells.

9. The method as recited in claim 8,
wherein, prior to the debindering process, the hollow bodies are introduced into the cells of the molded article, which is in the form of a green compact.

10. The method as recited in claim 8,
wherein, following the debindering process, the hollow bodies are introduced into the cells of the molded article, which is in the form of a brown compact.

11. The method as recited in claim 8,
wherein the homogeneous mass used for injection molding is obtained from metal powder, and wherein the hollow bodies are metallic hollow bodies or hollow bodies that have been metallized on the outer surfaces thereof.

12. The method as recited in claim 8,
wherein the homogeneous mass used for injection molding is obtained from ceramic powder, and wherein the hollow bodies are ceramic hollow bodies or hollow bodies that have been ceramitized on the outer surfaces thereof are used as hollow bodies.

13. The method as recited in claim 8,
wherein adapting in size the at least one hollow body to the cells of the molded article.

14. The method as recited in claim 8,
wherein adapting in shape the at least one hollow body to the cells of the molded article.

15. The method as recited in claim 8,
wherein, cooling the hollow bodies to a temperature that is lower than that of the molded article prior to introducing the hollow bodies into the cells of the molded article.
